(19) United States
(12) Patent Application Publication
(10) Pub. No.: US 2013/0053531 A1
(43) Pub. Date: Feb. 28, 2013

(54) Method for Minimizing Process Disruptions During Formation of a Liquid Crystalline Polymer

(71) Applicants: Kamlesh P. Nair, Florence, KY (US); Steven D. Gray, Mequon, WI (US)

(72) Inventors: Kamlesh P. Nair, Florence, KY (US); Steven D. Gray, Mequon, WI (US)

(73) Assignee: TICONA LLC, Florence, KY (US)

(21) Appl. No.: 13/594,903

(22) Filed: Aug. 27, 2012

Related U.S. Application Data
(60) Provisional application No. 61/528,392, filed on Aug. 29, 2011.
(60) Provisional application No. 61/664,828, filed on Jun. 27, 2012.

(51) Int. Cl. C08G 63/80

(52) U.S. Cl. 528/190

(57) ABSTRACT

A method for lowering melt viscosity of a liquid crystalline polymer as it is formed in a reactor vessel. More particularly, a reaction mixture is initially supplied to the reactor vessel that contains two or more precursor monomers (e.g., acetylated or non-acetylated). The reaction mixture is heated to an elevated temperature under agitation to initiate formation of the polymer. After a certain period of time, an aromatic amide oligomer is added to the reaction mixture. Among other things, the present inventors have discovered that such an oligomer can serve as a flow aid by altering intermolecular polymer chain interactions, thereby lowering the overall viscosity of the polymer matrix under shear. This minimizes the likelihood of “freeze off” of the polymer within the reactor vessel and limits the impact of process disruptions on the production of the liquid crystalline polymer.

### RELATED APPLICATIONS

The present application claims priority to U.S. provisional application Ser. Nos. 61/528,392, filed on Aug. 29, 2011, and 61/664,828, filed on Jun. 27, 2012, which are incorporated herein in their entirety by reference thereto.

### BACKGROUND OF THE INVENTION

Thermotropic liquid crystalline polymers are condensation polymers that have relatively rigid and linear polymer chains so that they melt to form a liquid crystalline phase. A typical process for producing liquid crystalline aromatic polyesters involves mixing one or more aromatic diols and dicarboxylic acids and/or hydroxycarboxylic acids with enough of a carboxylic acid anhydride (e.g., acetic anhydride) to acetylate the hydroxyl groups of the diols and/or hydroxycarboxylic acids present. Once formed, the acetylated monomers are thereafter heated to a high temperature to initiate a condensation reaction in which the monomers are converted to a polymer. To favor a reaction equilibrium that optimizes the production of a high molecular weight polymer, byproducts of the condensation reaction (e.g., acetic acid, phenolic derivatives, etc.) are generally removed. This is typically accomplished by subjecting the reaction mixture to a strong vacuum pressure.

During polymerization, the mixture within the reaction vessel may be agitated to facilitate good heat and mass transfer, and thus help ensure material homogeneity and minimize byproduct formation. As polycondensation continues the melt viscosity of the polymer increases with the polymer molecular weight. This, in turn, requires that the agitator overcome even greater viscous forces, which is reflected by a continuous increase in agitator torque (at a constant rotational velocity). Therefore, agitator torque can be a reflection of melt viscosity, and is sometimes used to monitor the extent of the polymerization reaction. While monitoring agitator torque can help ensure a consistent product, rapid increases in melt viscosity can still lead to serious problems during commercial production. For instance, unexpected agitator strain during production can be attributed to the presence of impurities in the mixture, unbalanced catalyst/monomer stoichiometry, etc. Process disruptions (e.g., power outages) can also lead to agitator shutdown and pose a serious problem as the melt viscosity increases to a point where the polymer is not easily removed from the reactor. This problem is commonly known as “freeze off” of the polymer within the reactor.

As such, a need exists for a technique to limit the impact of process disruptions on the production of liquid crystalline polymers, and more particularly for a technique of minimizing “freeze off” of the polymer within the reactor vessel.

### SUMMARY OF THE INVENTION

In accordance with one embodiment of the present invention, a method for forming a liquid crystalline polymer is disclosed. The method comprises supplying two or more monomers to a reactor vessel to form a reaction mixture, wherein the monomers are precursors for the liquid crystalline polymer; heating the reaction mixture to initiate a melt polycondensation reaction; agitating the heated reaction mixture; and introducing an aromatic amide oligomer into the reactor vessel during agitation of the reaction mixture. The oligomer has a molecular weight of about 3,000 grams per mole or less and contains from 1 to 15 amide functional groups per molecule.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is the Proton NMR characterization for N1,N4-diphenylterephthalamide (Compound A);

FIG. 2 is the Proton NMR characterization for N1,N4-diphenylisoterephthalamide (Compound B);

FIG. 3 is the Proton NMR characterization for N1,N4-bis(2,3,4,5,6-pentafluorophenyl)terephthalamide (Compound C);

FIG. 4 is the Proton NMR characterization for N1,N3-bis(4-benzamidophenyl)benzene-1,3-dicarboxamide (Compound F2);

FIG. 5 is the Proton NMR characterization for N1,N3-bis(3-benzamidophenyl)benzene-1,3-dicarboxamide (Compound G2); and

FIG. 6 is the Proton NMR characterization for N1,N3,N5-triphenylbenzene-1,3,5-tricarboxamide (Compound J).

### DETAILED DESCRIPTION OF REPRESENTATIVE EMBODIMENTS

### Definitions

It is to be understood that the terminology used herein is for the purpose of describing particular embodiments only and is not intended to limit the scope of the present invention.

“Alkyl” refers to monovalent saturated aliphatic hydrocarbyl groups having from 1 to 10 carbon atoms and, in some embodiments, from 1 to 6 carbon atoms. “C_{x-y}alkyl” refers to alkyl groups having from x to y carbon atoms. This term includes, by way of example, linear and branched hydrocarbyl groups such as methyl (CH₃), ethyl (CH₃CH₂), n-propyl (CH₃CH₂CH₂), isopropyl ((CH₃)₂CH), n-butyl (CH₃CH₂CH2CH₂), isobutyl ((CH₃)₂CHCH₂), sec-butyl ((CH₃)(CH₃CH₂)CH), t-butyl ((CH₃)₃C), n-pentyl (CH₃CH₂CH₂CH₂CH₂), and neopentyl ((CH₃)₃CCH₂).

“Alkenyl” refers to a linear or branched hydrocarbyl group having from 2 to 10 carbon atoms and in some embodiments from 2 to 6 carbon atoms or 2 to 4 carbon atoms and having at least 1 site of vinyl unsaturation (>C═C<). For example, (Cₓ-C_{y})alkenyl refers to alkenyl groups having from x to y carbon atoms and is meant to include for example, ethenyl, propenyl, 1,3-butadienyl, and so forth.

“Alkynyl” refers to refers to a linear or branched monovalent hydrocarbon radical containing at least one triple bond. The term “alkynyl” may also include those hydrocarbyl groups having other types of bonds, such as a double bond and a triple bond.

“Aryl” refers to an aromatic group of from 3 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” applies when the point of attachment is at an aromatic carbon atom (e.g., 5,6,7,8 tetrahydronaphthalene-2-yl is an aryl group as its point of attachment is at the 2-position of the aromatic phenyl ring).

“Cycloalkyl” refers to a saturated or partially saturated cyclic group of from 3 to 14 carbon atoms and no ring heteroatoms and having a single ring or multiple rings including fused, bridged, and spiro ring systems. For multiple ring systems having aromatic and non-aromatic rings that have no ring heteroatoms, the term “cycloalkyl” applies when the point of attachment is at a non-aromatic carbon atom (e.g. 5,6,7,8,-tetrahydronaphthalene-5-yl). The term “cycloalkyl” includes cycloalkenyl groups, such as adamantyl, cyclopropyl, cyclobutyl, cyclopentyl, cyclooctyl, and cyclohexenyl. The term “cycloalkenyl” is sometimes employed to refer to a partially saturated cycloalkyl ring having at least one site of >C═C< ring unsaturation.

“Halo” or “halogen” refers to fluoro, chloro, bromo, and iodo.

“Haloalkyl” refers to substitution of alkyl groups with 1 to 5 or in some embodiments 1 to 3 halo groups.

“Heteroaryl” refers to an aromatic group of from 1 to 14 carbon atoms and 1 to 6 heteroatoms selected from oxygen, nitrogen, and sulfur and includes single ring (e.g. imidazolyl) and multiple ring systems (e.g. benzimidazol-2-yl and benzimidazol-6-yl). For multiple ring systems, including fused, bridged, and spiro ring systems having aromatic and non-aromatic rings, the term “heteroaryl” applies if there is at feast one ring heteroatom and the point of attachment is at an atom of an aromatic ring (e.g. 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide for the N oxide (N→O), sulfinyl, or sulfonyl moieties. Examples of heteroaryl groups include, but are not limited to, pyridyl, furanyl, thienyl, thiazolyl, isothiazolyl, triazolyl, imidazolyl, imidazolinyl, isoxazolyl, pyrrolyl, pyrazolyl, pyridazinyl, pyrimidinyl, purinyl, phthalazyl, naphthylpryidyl, benzofuranyl, tetrahydrobenzofuranyl, isobenzofuranyl, benzothiazolyl, benzoisothiazolyl, benzotriazolyl, indolyl, isoindolyl, indolizinyl, dihydroindolyl, indazolyl, indolinyl, benzoxazolyl, quinolyl, isoquinolyl, quinolizyl, quianazolyl, quinoxalyl, tetrahydroquinolinyl, isoquinolyl, quinazolinonyl, benzimidazolyl, benzisoxazolyl, benzothienyl, benzopyridazinyl, pteridinyl, carbazolyl, carbolinyl, phenanthridinyl, acridinyl, phenanthrolinyl, phenazinyl, phenoxazinyl, phenothiazinyl, and phthalimidyl.

“Heterocyclic” or “heterocycle” or “heterocycloalkyl” or “heterocyclyl” refers to a saturated or partially saturated cyclic group having from 1 to 14 carbon atoms and from 1 to 6 heteroatoms selected from nitrogen, sulfur, or oxygen and includes single ring and multiple ring systems including fused, bridged, and spiro ring systems. For multiple ring systems having aromatic and/or non-aromatic rings, the terms “heterocyclic”, “heterocycle”, “heterocycloalkyl”, or “heterocyclyl” apply when there is at least one ring heteroatom and the point of attachment is at an atom of a non-aromatic ring (e.g. decahydroquinolin-6-yl). In some embodiments, the nitrogen and/or sulfur atom(s) of the heterocyclic group are optionally oxidized to provide for the N oxide, sulfinyl, and sulfonyl moieties. Examples of heterocyclyl groups include, but are not limited to, azetidinyl, tetrahydropyranyl, piperidinyl, N-methylpiperidin-3-yl, piperazinyl, N-methylpyrrolidin-3-yl, 3-pyrrolidinyl, 2-pyrrolidon-1-yl, morpholinyl, thiomorpholinyl, imidazolidinyl, and pyrrolidinyl.

It should be understood that the aforementioned definitions encompass unsubstituted groups, as well as groups substituted with one or more other functional groups as is known in the art. For example, an aryl, heteroaryl, cycloalkyl, or heterocyclyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, thione, phosphate, phosphonate, phosphinate, phosphoramidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc., as well as combinations of such substituents.

“Liquid crystalline polymer” or “liquid crystal polymer” refers to a polymer that can possess a rod-like structure that allows it to exhibit liquid crystalline behavior in its molten state (e.g., thermotropic nematic state). The polymer may contain aromatic units (e.g., aromatic polyesters, aromatic polyesteramides, etc.) so that it is wholly aromatic (e.g., containing only aromatic units) or partially aromatic (e.g., containing aromatic units and other units, such as cycloaliphatic units). The polymer may also be fully crystalline or semi-crystalline in nature.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a method for lowering melt viscosity of a liquid crystalline polymer as it is formed in the reactor vessel. More particularly, a reaction mixture is initially supplied to a reactor vessel that contains two or more precursor monomers (e.g., acetylated or non-acetylated). The reaction mixture is heated to an elevated temperature under agitation to initiate formation of the polymer. After a certain period of time, an aromatic amide oligomer is added to the reaction mixture. Among other things, the present inventors have discovered that such an oligomer can serve as a “flow aid” by altering intermolecular polymer chain interactions, thereby lowering the overall viscosity of the polymer matrix under shear. This minimizes the likelihood of “freeze off” of the polymer within the reactor vessel and limits the impact of process disruptions on the production of the liquid crystalline polymer. Another benefit of the oligomer is that it is not easily volatized or decomposed. This allows the oligomer to be added to the reaction mixture while it is still at relatively high temperatures. Without intending to be limited by theory, it is believed that active hydrogen atoms of the amide functional groups are capable of forming a hydrogen bond with the backbone of liquid crystalline polyesters or polyesteramides. Such hydrogen bonding strengthens the attachment of the oligomer to the liquid crystalline polymer and thus minimizes the likelihood that it becomes volatilized. While providing the benefits noted, the aromatic amide oligomer does not generally react with the polymer backbone of the liquid crystalline polymer to any appreciable extent so that the mechanical properties of the polymer are not adversely impacted.

The aromatic amide oligomer generally has a relatively low molecular weight so that it can effectively serve as a flow aid for the polymer composition. For example, the oligomer typically has a molecular weight of about 3,000 grams per mole or less, in some embodiments from about 50 to about 2,000 grams per mole, in some embodiments from about 100 to about 1,500 grams per mole, and in some embodiments, from about 200 to about 1,200 grams per mole. In addition to possessing a relatively low molecular weight, the oligomer also generally possesses high amide functionality so it is capable of undergoing a sufficient degree of hydrogen bonding with the liquid crystalline polymer. The degree of amide functionality for a given molecule may be characterized by its “amide equivalent weight”, which reflects the amount of a compound that contains one molecule of an amide functional group and may be calculated by dividing the molecular weight of the compound by the number of amide groups in the molecule. For example, the aromatic amide oligomer may contain from 1 to 15, in some embodiments from 2 to 10, and in some embodiments, from 2 to 8 amide functional groups per molecule. The amide equivalent weight may likewise be from about 10 to about 1,000 grams per mole or less, in some embodiments from about 50 to about 500 grams per mole, and in some embodiments, from about 100 to about 300 grams per mole.

As indicated above, it is desirable that the amide oligomer is also generally unreactive so that it does not form covalent bonds with the liquid crystalline polymer backbone. To help better minimize reactivity, the oligomer typically contains a core formed from one or more aromatic rings (including heteroaromatic). The oligomer may also contain terminal groups formed from one or more aromatic rings and/or cycloalkyl groups. Such an “aromatic” oligomer thus possesses little, if any, reactivity with the base liquid crystalline polymer. For example, one embodiment of such an aromatic amide oligomer is provided below in Formula (I):

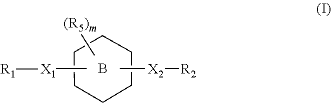

wherein,

ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;

R₅ is halo, haloalkyl, alkyl, alkenyl, aryl, heteroaryl, cycloalkyl, or heterocyclyl;

m is from 0 to 4;

X₁ and X₂ are independently C(O)HN or NHC(O); and

R₁ and R₂ are independently selected from aryl, heteroaryl, cycloalkyl, and heterocyclyl.

In certain embodiments, Ring B may be selected from the following:

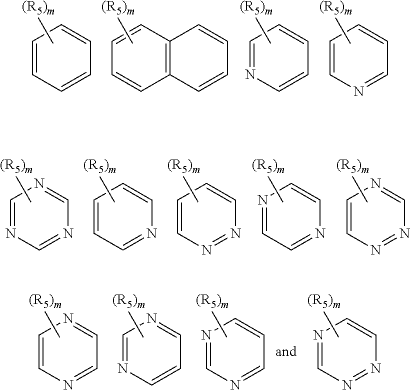

wherein,

m is 0, 1, 2, 3, or 4, in some embodiments m is 0, 1, or 2, in some embodiments m is 0 or 1, and in some embodiments, m is 0; and

R₅ is halo, haloalkyl, alkyl, alkenyl, aryl, heteroaryl, cycloalkyl, or heterocyclyl. Preferably, ring B is phenyl.

In certain embodiments, the oligomer is a di-functional compound in that Ring B is directly bonded to only two (2) amide groups (e.g., C(O)HN or NHC(O)). In such embodiments, m in Formula (I) is preferably 0. Of course, in certain embodiments, Ring B may also be directly bonded to three (3) or more amide groups. For example, one embodiment of such a compound is provided by general formula (II):

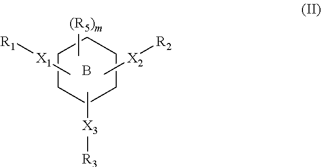

wherein,

ring B, R₅, X₁, X₂, R₁, and R₂ are as defined above;

m is from 0 to 3;

X₃ is C(O)HN or NHC(O); and

R₃ is selected from aryl, heteroaryl, cycloalkyl, and heterocyclyl.

Another embodiment of such a compound is provided by general formula (III):

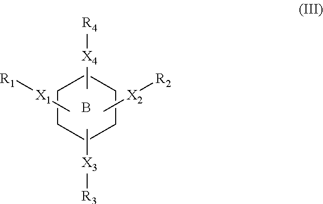

wherein,

ring B, R₅, X₁, X₂, X₃, R₁, R₂, and R₃ are as defined above;

X₄ is C(O)HN or NHC(O); and

R₄ is selected from aryl, heteroaryl, cycloalkyl, and heterocyclyl.

In some embodiments, R₁, R₂, R₃, and/or R₄ in the structures noted above may be selected from the following:

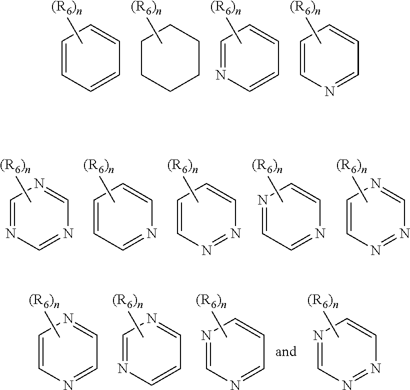

wherein,

n is 0, 1, 2, 3, 4, or 5, in some embodiments n is 0, 1, or 2, and in some embodiments, n is 0 or 1; and

R₆ is halo, haloalkyl, alkyl, alkenyl, alkynyl, aryl, heteroaryl, cycloalkyl, or heterocyclyl.

In one embodiment, the aromatic amide oligomer has the following general formula (IV):

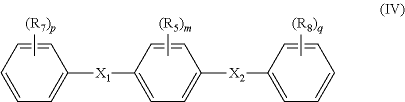

wherein,

X₁ and X₂ are independently C(O)HN or NHC(O);

R₅, R₇, and R₈ are independently selected from halo, haloalkyl, alkyl, alkenyl, alkynyl, aryl, heteroaryl, cycloalkyl, and heterocyclyl;

m is from 0 to 4; and

p and q are independently from 0 to 5.

In another embodiment, the aromatic amide oligomer has the following general formula (V):

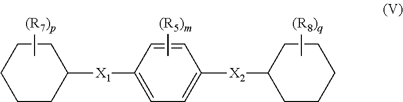

wherein,

X₁, X₂, R₅, R₇, R₈, m, p, and q are as defined above.

For example, in certain embodiments, m, p, and q in Formula (IV) and Formula (V) may be equal to 0 so that the core and terminal groups are unsubstituted. In other embodiments, m may be 0 and p and q may be from 1 to 5. In such embodiments, for example, R₇ and/or R₈ may be halo (e.g., fluorine). In other embodiments, R₇ and/or R₈ may be aryl (e.g., phenyl), cycloalkyl (e.g., cyclohexyl), or aryl and/or cycloalkyl substituted with an amide group having the structure: —C(O)R₁₂N— or —NR₁₃C(O)—, wherein R₁₂ and R₁₃ are independently selected from hydrogen, alkyl, alkenyl, alkynyl, aryl, heteroaryl, cycloalkyl, and heterocyclyl. In one particular embodiment, for example, R₇ and/or R₈ are phenyl substituted with —C(O)HN— or —NHC(O)—. In yet other embodiments, R₇ and/or R₈ may be heteroaryl (e.g., pyridinyl).

In yet another embodiment, the aromatic amide oligomer has the following general formula (VI):

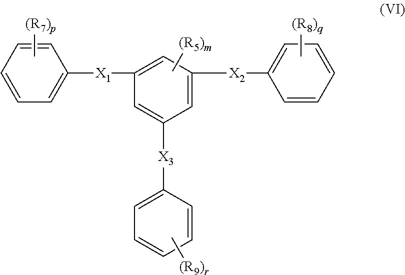

wherein,

X₁, X₂, and X₃ are independently C(O)HN or NHC(O);

R₅, R₇, R₈, and R₉ are independently selected from halo, haloalkyl, alkyl, alkenyl, alkynyl, aryl, heteroaryl, cycloalkyl, and heterocyclyl;

m is from 0 to 3; and

p, q, and r are independently from 0 to 5.

In yet another embodiment, the aromatic amide oligomer has the following general formula (VII):

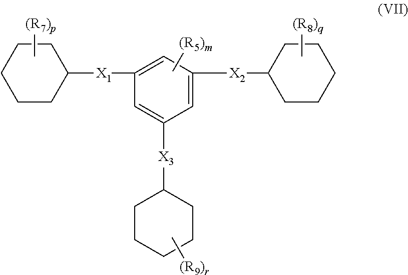

wherein,

X₁, X₂, X₃, R₅, R₇, R₈, R₉, m, p, q, and r are as defined above.

For example, in certain embodiments, m, p, q, and r in Formula (VI) or in Formula (VII) may be equal to 0 so that the core and terminal aromatic groups are unsubstituted. In other embodiments, m may be 0 and p, q, and r may be from to 5. In such embodiments, for example, R₇, R₈, and/or R₉ may be halo (e.g., fluorine). In other embodiments, R₇, R₈, and/or R₉ may be aryl (e.g., phenyl), cycloalkyl (e.g., cyclohexyl), or aryl and/or cycloalkyl substituted with an amide group having the structure: —C(O)R₁₂N— or —NR₁₃C(O)—, wherein R₁₂ and R₁₃ are independently selected from hydrogen, alkyl, alkenyl, alkynyl, aryl, heteroaryl, cycloalkyl, and heterocyclyl. In one particular embodiment, for example, R₇, R₈, and/or R₉ are phenyl substituted with —C(O)HN— or —NHC(O)—. In yet other embodiments, R₇, R₈, and/or R₉ may be heteroaryl (e.g., pyridinyl).

Specific embodiments of the aromatic amide oligomer of the present invention are also set forth in the table below:

| Cmpd | | |
|---|---|---|
| # | Structure | Name |
| A | 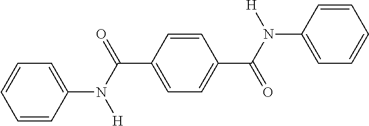 [SMILES: O=C(Nc1ccccc1)c1ccc(C(=O)Nc2ccccc2)cc1] | N1,N4- diphenylterephthalamide |
| B | 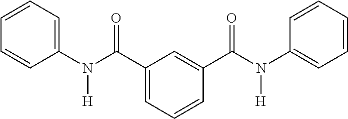 [SMILES: O=C(Nc1ccccc1)c1cccc(C(=O)Nc2ccccc2)c1] | N1,N4- diphenylisoterephthalamide |
| C | 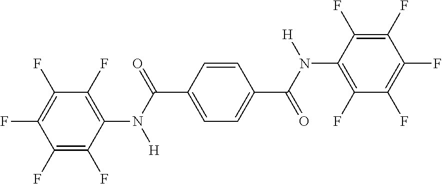 [SMILES: O=C(Nc1c(F)c(F)c(F)c(F)c1F)c1ccc(C(=O)Nc2c(F)c(F)c(F)c(F)c2F)cc1] | N1,N4-bis(2,3,4,5,6- pentafluorophenyl) terephthalamide |
| D | 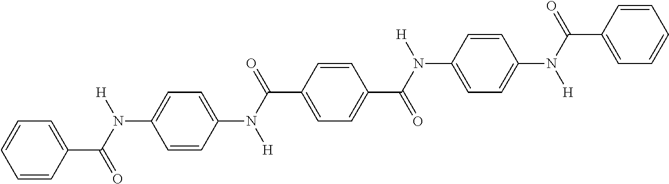 [SMILES: O=C(Nc1ccc(NC(=O)c2ccc(C(=O)Nc3ccc(NC(=O)c4ccccc4)cc3)cc2)cc1)c1ccccc1] | N1,N4-bis(4- benzamidophenyl) terephthalamide |
| E | 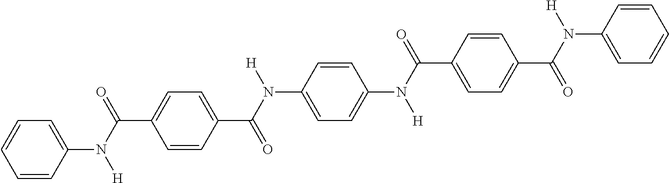 [SMILES: O=C(Nc1ccccc1)c1ccc(C(=O)Nc2ccc(NC(=O)c3ccc(C(=O)Nc4ccccc4)cc3)cc2)cc1] | N4-phenyl-N1-[4-[[4- (phenylcarbamoyl)benzoyl] amino]phenyl] terephthalamide |
| F1 | 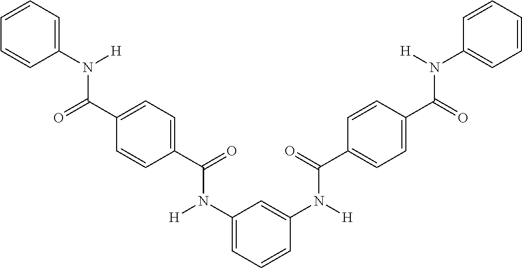 [SMILES: O=C(Nc1ccccc1)c1ccc(C(=O)Nc2cccc(NC(=O)c3ccc(C(=O)Nc4ccccc4)cc3)c2)cc1] | N4-phenyl-N1-[3-[[4- (phenylcarbamoyl)benzoyl] amino]phenyl] terephthalamide |
| F2 | 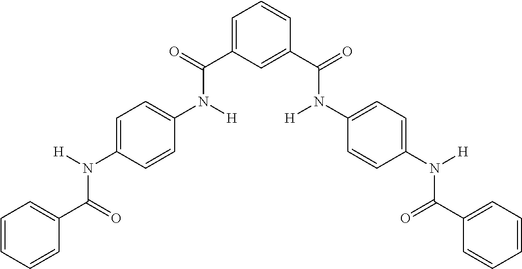 [SMILES: O=C(Nc1ccc(NC(=O)c2cccc(C(=O)Nc3ccc(NC(=O)c4ccccc4)cc3)c2)cc1)c1ccccc1] | N1,N3-bis(4- benzamidophenyl)benzene- 1,3-dicarboxamide |
| G1 | 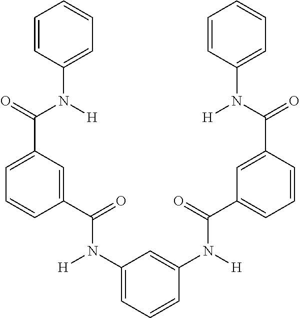 [SMILES: O=C(Nc1ccccc1)c1cccc(C(=O)Nc2cccc(NC(=O)c3cccc(C(=O)Nc4ccccc4)c3)c2)c1] | N3-phenyl-N1-[3-[[3- (phenylcarbamoyl)benzoyl] amino]phenyl]benzene-1,3- dicarboxamide |
| G2 | 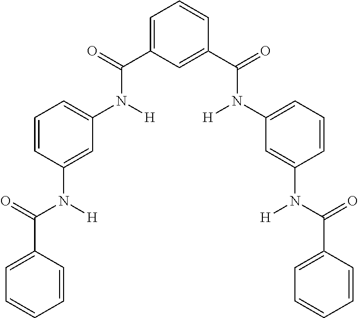 [SMILES: O=C(Nc1cccc(NC(=O)c2cccc(C(=O)Nc3cccc(NC(=O)c4ccccc4)c3)c2)c1)c1ccccc1] | N1,N3-bis(3- benzamidophenyl)benzene- 1,3-dicarboxamide |
| H | 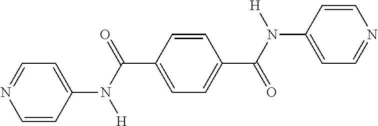 [SMILES: O=C(Nc1ccncc1)c1ccc(C(=O)Nc2ccncc2)cc1] | N1,N4-bis(4- pyridyl)terephthalamide |
| I | 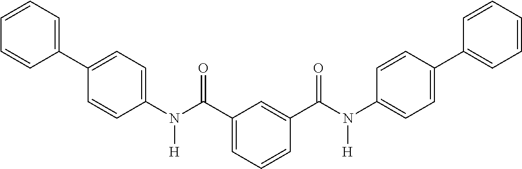 [SMILES: O=C(Nc1ccc(-c2ccccc2)cc1)c1cccc(C(=O)Nc2ccc(-c3ccccc3)cc2)c1] | N1,N3-bis(4- phenylphenyl)benzene-1,3- dicarboxamide |
| J | 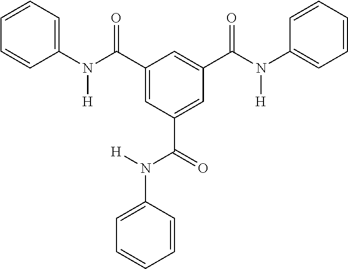 [SMILES: O=C(Nc1ccccc1)c1cc(C(=O)Nc2ccccc2)cc(C(=O)Nc2ccccc2)c1] | N1,N3,N5-triphenylbenzene- 1,3,5-tricarboxamide |
| K | 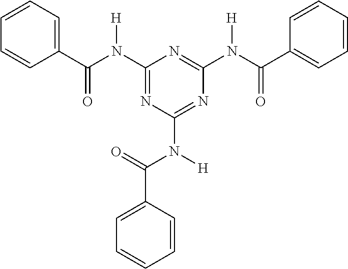 [SMILES: O=C(Nc1nc(NC(=O)c2ccccc2)nc(NC(=O)c2ccccc2)n1)c1ccccc1] | N-(4,6-dibenzamido-1,3,5- triazin-2-yl)benzamide |
| L1 | 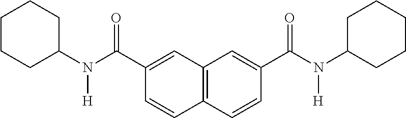 [SMILES: O=C(NC1CCCCC1)c1ccc2ccc(C(=O)NC3CCCCC3)cc2c1] | N2,N7- dicyclohexylnaphthalene- 2,7-dicarboxamide |
| L2 | 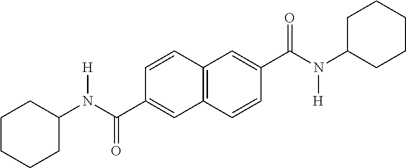 [SMILES: O=C(NC1CCCCC1)c1ccc2cc(C(=O)NC3CCCCC3)ccc2c1] | N2,N6- dicyclohexylnaphthalene- 2,6-dicarboxamide |
| M1 | 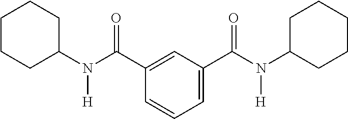 [SMILES: O=C(NC1CCCCC1)c1cccc(C(=O)NC2CCCCC2)c1] | 1,3-Benzenedicarboxamide, N1,N3-dicyclohexyl |
| M2 | 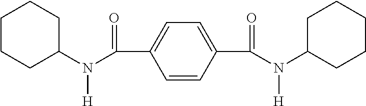 [SMILES: O=C(NC1CCCCC1)c1ccc(C(=O)NC2CCCCC2)cc1] | 1,4-Benzenedicarboxamide, N1,N3-dicyclohexyl |

The precursor monomers employed during the formation of the liquid crystalline polymer may generally vary as is known in the art. For example, suitable thermotropic liquid crystalline polymers may include instance, aromatic polyesters, aromatic poly(esteramides), aromatic poly(estercarbonates), aromatic polyamides, etc., and may likewise contain repeating units formed from one or more aromatic or aliphatic hydroxycarboxylic acids, aromatic or aliphatic dicarboxylic acids, aromatic or aliphatic diols, aromatic or aliphatic aminocarboxylic acids, aromatic or aliphatic amines, aromatic or aliphatic diamines, etc., as well as combinations thereof.

Aromatic polyesters, for instance, may be obtained by polymerizing (1) two or more aromatic hydroxycarboxylic acids; (2) at least one aromatic hydroxycarboxylic acid, at least one aromatic dicarboxylic acid, and at least one aromatic diol; and/or (3) at least one aromatic dicarboxylic acid and at least one aromatic dial. Examples of suitable aromatic hydroxycarboxylic acids include, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof. Examples of suitable aromatic dicarboxylic acids include terephthalic acid; isophthalic acid; 2,6-naphthalenedicarboxylic acid; diphenyl ether-4,4′-dicarboxylic acid; 1,6-naphthalenedicarboxylic acid; 2,7-naphthalenedicarboxylic acid; 4,4′-dicarboxybiphenyl; bis(4-carboxyphenyl)ether; bis(4-carboxyphenyl)butane; bis(4-carboxyphenyl)ethane; bis(3-carboxyphenyl)ether; bis(3-carboxyphenyl)ethane, etc., as well as alkyl, alkoxy, aryl and halogen substituents thereof. Examples of suitable aromatic dials include hydroquinone; resorcinol; 2,6-dihydroxynaphthalene; 2,7-dihydroxynaphthalene; 1,6-dihydroxynaphthalene; 4,4′-dihydroxybiphenyl; 3,3′-dihydroxybiphenyl; 3,4′-dihydroxybiphenyl; 4,4′-dihydroxybiphenyl ether; bis(4-hydroxyphenyl)ethane, etc., as well as alkyl, alkoxy, aryl and halogen substituents thereof. In one particular embodiment, the aromatic polyester contains monomer repeat units derived from 4-hydroxybenzoic acid and 2,6-hydroxynaphthoic acid. The monomer units derived from 4-hydroxybenzoic acid may constitute from about 45% to about 85% (e.g., 73%) of the polymer on a mole basis and the monomer units derived from 2,6-hydroxynaphthoic acid may constitute from about 15% to about 55% (e.g., 27%) of the polymer on a mole basis. Such aromatic polyesters are commercially available from Ticona, LLC under the trade designation VECTRA® A. The synthesis and structure of these and other aromatic polyesters may be described in more detail in U.S. Pat. Nos. 4,161,470; 4,473,682; 4,522,974; 4,375,530; 4,318,841; 4,256,624; 4,219,461; 4,083,829; 4,184,996; 4,279,803; 4,337,190; 4,355,134; 4,429,105; 4,393,191; 4,421,908; 4,434,262; and 5,541,240.

Liquid crystalline polyesteramides may likewise be obtained by polymerizing (1) at least one aromatic hydroxycarboxylic acid and at least one aromatic aminocarboxylic acid; (2) at least one aromatic hydroxycarboxylic acid, at least one aromatic dicarboxylic acid, and at least one aromatic amine and/or diamine optionally having phenolic hydroxy groups; and (3) at least one aromatic dicarboxylic acid and at least one aromatic amine and/or diamine optionally having phenolic hydroxy groups. Suitable aromatic amines and diamines may include, for instance, 3-aminophenol; 4-aminophenol; 1,4-phenylenediamine; 1,3-phenylenediamine, etc., as well as alkyl, alkoxy, aryl and halogen substituents thereof. In one particular embodiment, the aromatic polyesteramide contains monomer units derived from 2,6-hydroxynaphthoic acid, terephthalic acid, and 4-aminophenol. The monomer units derived from 2,6-hydroxynaphthoic acid may constitute from about 35% to about 85% of the polymer on a mole basis (e.g., 60%), the monomer units derived from terephthalic acid may constitute from about 5% to about 50% (e.g., 20%) of the polymer on a mole basis, and the monomer units derived from 4-aminophenol may constitute from about 5% to about 50% (e.g., 20%) of the polymer on a mole basis. Such aromatic polyesters are commercially available from Ticona, LLC under the trade designation VECTRA® B. In another embodiment, the aromatic polyesteramide contains monomer units derived from 2,6-hydroxynaphthoic acid, and 4-hydroxybenzoic acid, and 4-aminophenol, as well as other optional monomers (e.g., 4,4′-dihydroxybiphenyl and/or terephthalic acid). The synthesis and structure of these and other aromatic poly(esteramides) may be described in more detail in U.S. Pat. Nos. 4,339,375; 4,355,132; 4,351,917; 4,330,457; 4,351,918; and 5,204,443.

Regardless of their particular constituents, the liquid crystalline polymers may be prepared by introducing the appropriate monomer(s) (e.g., aromatic hydroxycarboxylic acid, aromatic dicarboxylic acid, aromatic diol, aromatic amine, aromatic diamine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner, which are incorporated herein in their entirety by reference thereto for all relevant purposes. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as referenced above and known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation. In addition to monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 210° C. to about 400° C., and in some embodiments, from about 250° C. to about 350° C. For instance, one suitable technique for forming an aromatic polyester may include charging precursor monomers (e.g., 4-hydroxybenzoic acid and 2,6-hydroxynaphthoic acid) and acetic anhydride into the reactor, heating the mixture to a temperature of from about 90° C. to about 150° C. to acetylize a hydroxyl group of the monomers (e.g., forming acetoxy), and then increasing the temperature to a temperature of from about 210° C. to about 400° C. to carry out melt polycondensation. As the final polymerization temperatures are approached, volatile byproducts of the reaction (e.g., acetic acid) may also be removed so that the desired molecular weight may be readily achieved. The viscous reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

In accordance with the present invention, the aromatic amide oligomer is also added to the polymerization apparatus to lower the melt viscosity of the mixture and minimize the likelihood of the “freeze off” phenomenon. Although it may be introduced at any time, it is typically desired to apply the oligomer after optional acetylation of the monomers and after melt polycondensation has been initiated. In one embodiment, for example, the oligomer is introduced into the apparatus a certain period of time after the suctional pressure is initiated to help remove byproducts from the reaction mixture. This time may vary, but is typically from about 10 to about 800 minutes, and in some embodiments, from about 50 to about 250 minutes. The oligomer may be applied during and/or after the suctional pressure is applied.

The relative amount of the aromatic amide oligomer added to the reaction mixture may be selected to help achieve a balance between viscosity and mechanical properties. More particularly, high oligomer contents can result in low viscosity, but too high of a content may reduce the viscosity to such an extent that the oligomer adversely impacts the melt strength of the reaction mixture. In most embodiments, for example, the aromatic amide oligomer is employed in an amount of from about 0.1 to about 5 parts, in some embodiments from about 0.2 to about 4 parts, and in some embodiments, from about 0.3 to about 1.5 parts by weight relative to 100 parts by weight of the reaction mixture. The aromatic amide oligomers may, for example, constitute from about 0.1 wt. % to about 5 wt. %, in some embodiments from about 0.2 wt. % to about 4 wt. %, and in some embodiments, from about 0.3 wt. % to about 1.5 wt. % of the reaction mixture. Liquid crystalline polymers may likewise constitute from about 95 wt. % to about 99.9 wt. %, in some embodiments from about 96 wt. % to about 98.8 wt. %, and in some embodiments, from about 98.5 wt. % to about 99.7 wt. % of the reaction mixture. While referred to in terms of the reaction mixture, it should also be understood that the ratios and weight percentages may also be applicable to the final polymer composition. That is, the parts by weight of the oligomer relative to 100 parts by weight of liquid crystalline polymer and the percentage of the oligomer in the final polymer composition may be within the ranges noted above.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. The resin may also be in the form of a strand, granule, or powder. It should also be understood, however, that a subsequent solid phase polymerization may be conducted to further increase molecular weight. When carrying out solid-phase polymerization on a polymer obtained by melt polymerization, it is typically desired to select a method in which the polymer obtained by melt polymerization is solidified and then pulverized to form a powdery or flake-like polymer, followed by performing solid polymerization method, such as a heat treatment in a temperature range of 200° C. to 350° C. under an inert atmosphere (e.g., nitrogen).

Regardless of the particular method employed, the resulting liquid crystalline polymer typically has a number average molecular weight (Mₙ) of about 2,000 grams per mole or more, in some embodiments from about 4,000 grams per mole or more, and in some embodiments, from about 5,000 to about 30,000 grams per mole. Of course, it is also possible to form polymers having a lower molecular weight, such as less than about 2,000 grams per mole, using the method of the present invention. The intrinsic viscosity of the polymer composition, which is generally proportional to molecular weight, may likewise be about 2 deciliters per gram (“dL/g”) or more, in some embodiments about 3 dL/g or more, in some embodiments from about 4 to about 20 dL/g, and in some embodiments from about 5 to about 15 dL/g. Intrinsic viscosity may be determined in accordance with ISO-1628-5 using a 50/50 (v/v) mixture of pentafluorophenol and hexafluoroisopropanol, as described in more detail below. Due to the presence of the aromatic amide oligomer, the polymer composition may have a relatively low melt viscosity. For example, the polymer composition may have a melt viscosity of from about 0.5 to about 100 Pa-s, in some embodiments from about 1 to about 80 Pa-s, and in some embodiments, from about 2 to about 50 Pa-s, determined at a shear rate of 1000 seconds⁻¹. Melt viscosity may be determined in accordance with ISO Test No. 11443 (equivalent to ASTM Test No. 1238-70) at a temperature of 350° C.

The melting point of the polymer composition may also range from about 250° C. to about 400° C., in some embodiments from about 270° C. to about 380° C., and in some embodiments, from about 300° C. to about 360° C. Likewise, the crystallization temperature may range from about 200° C. to about 400° C., in some embodiments from about 250° C. to about 350° C., and in some embodiments, from about 280° C. to about 320° C. The melting and crystallization temperatures may be determined as is well known in the art using differential scanning calorimetry (“DSC”), such as determined by ISO Test No. 11357.

If desired, the resulting polymer composition may also be combined with a wide variety of other types of components to form a filled composition. For example, a filler material may be incorporated with the polymer composition to enhance strength. A filled composition can include a filler material such as a fibrous filler and/or a mineral filler and optionally one or more additional additives as are generally known in the art.

Mineral fillers may, for instance, be employed in the polymer composition to help achieve the desired mechanical properties and/or appearance. When employed, mineral fillers typically constitute from about 5 wt. % to about 60 wt. %, in some embodiments from about 10 wt. % to about 55 wt. %, and in some embodiments, from about 20 wt. % to about 50 wt. % of the polymer composition. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂(Si,Al)₄O₁₀[(OH)₂,(H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂.4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be particularly suitable. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof.

Fibers may also be employed as a filler material to further improve the mechanical properties. Such fibers generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments, from about 3,000 MPa to about 6,000 MPa. To help maintain an insulative property, which is often desirable for use in electronic components, the high strength fibers may be formed from materials that are also generally insulative in nature, such as glass, ceramics (e.g., alumina or silica), aramids (e.g., Kevlar® marketed by E. I, duPont de Nemours, Wilmington, Del.), polyolefins, polyesters, etc., as well as mixtures thereof. Glass fibers are particularly suitable, such as E-glass, A-glass, C-glass, D-glass, AR-glass, R-glass, S1-glass, S2-glass, etc., and mixtures thereof.

The volume average length of the fibers may be from about 50 to about 400 micrometers, in some embodiments from about 80 to about 250 micrometers, in some embodiments from about 100 to about 200 micrometers, and in some embodiments, from about 110 to about 180 micrometers. The fibers may also have a narrow length distribution. That is, at least about 70% by volume of the fibers, in some embodiments at least about 80% by volume of the fibers, and in some embodiments, at least about 90% by volume of the fibers have a length within the range of from about 50 to about 400 micrometers, in some embodiments from about 80 to about 250 micrometers, in some embodiments from about 100 to about 200 micrometers, and in some embodiments, from about 110 to about 180 micrometers. The fibers may also have a relatively high aspect ratio (average length divided by nominal diameter) to help improve the mechanical properties of the resulting polymer composition. For example, the fibers may have an aspect ratio of from about 2 to about 50, in some embodiments from about 4 to about 40, and in some embodiments, from about 5 to about 20 are particularly beneficial. The fibers may, for example, have a nominal diameter of about 10 to about 35 micrometers, and in some embodiments, from about 15 to about 30 micrometers.

The relative amount of the fibers in the filled polymer composition may also be selectively controlled to help achieve the desired mechanical properties without adversely impacting other properties of the composition, such as its flowability. For example, the fibers may constitute from about 2 wt. % to about 40 wt. %, in some embodiments from about 5 wt. % to about 35 wt. %, and in some embodiments, from about 6 wt. % to about 30 wt. % of the polymer composition. Although the fibers may be employed within the ranges noted above, small fiber contents may be employed while still achieving the desired mechanical properties. For example, the fibers can be employed in small amounts such as from about 2 wt. % to about 20 wt. %, in some embodiments, from about 5 wt. % to about 16 wt. %, and in some embodiments, from about 6 wt. % to about 12 wt. %.

Still other additives that can be included in the composition may include, for instance, antimicrobials, pigments (e.g., carbon black), antioxidants, stabilizers, surfactants, waxes, solid solvents, and other materials added to enhance properties and processability. Lubricants, for instance, may be employed in the polymer composition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters, Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

The present invention may be better understood with reference to the following examples.

### Test Methods

Melt Viscosity:

The melt viscosity (Pa-s) was determined in accordance with ISO Test No. 11443 at 350° C. and at a shear rate of 400 s⁻¹ and 1000 s⁻¹ using a Dynisco 7001 capillary rheometer. The rheometer orifice (die) had a diameter of 1 mm, length of 20 mm, L/D ratio of 20.1, and an entrance angle of 180°. The diameter of the barrel was 9.55 mm±0.005 mm and the length of the rod was 233.4 mm.

Intrinsic Viscosity:

The intrinsic viscosity (“IV”) was measured in accordance with ISO-1628-5 using a 50/50 (v/v) mixture of pentafluorophenol and hexafluoroisopropanol. Each sample was prepared in duplicate by weighing about 0.02 grams into a 22 mL vial. 10 mL of pentafluorophenol (“PFP”) was added to each vial and the solvent. The vials were placed in a heating block set to 80° C. overnight. The following day 10 mL of hexafluoroisopropanol (“HFIP”) was added to each vial. The final polymer concentration of each sample was about 0.1%. The samples were allowed to cool to room temperature and analyzed using a PolyVisc automatic viscometer.

Melting and Crystallization Temperatures:

The melting temperature (“Tm”) and crystallization temperature (“Tc”) were determined by differential scanning calorimetry (“DSC”) as is known in the art. The melting temperature is the differential scanning calorimetry (DSC) peak melt temperature as determined by ISO Test No. 11357. The crystallization temperature is determined from the cooling exotherm in the cooling cycle. Under the DSC procedure, samples were heated and cooled at 20° C. per minute as stated in ISO Standard 10350 using DSC measurements conducted on a TA Q2000 Instrument.

### Synthesis of N1,N4-Diphenylterephthalamide

### Compound A

The synthesis of Compound A from terephthaloyl chloride and aniline was performed according to the following scheme:

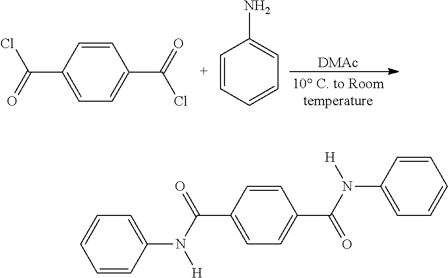

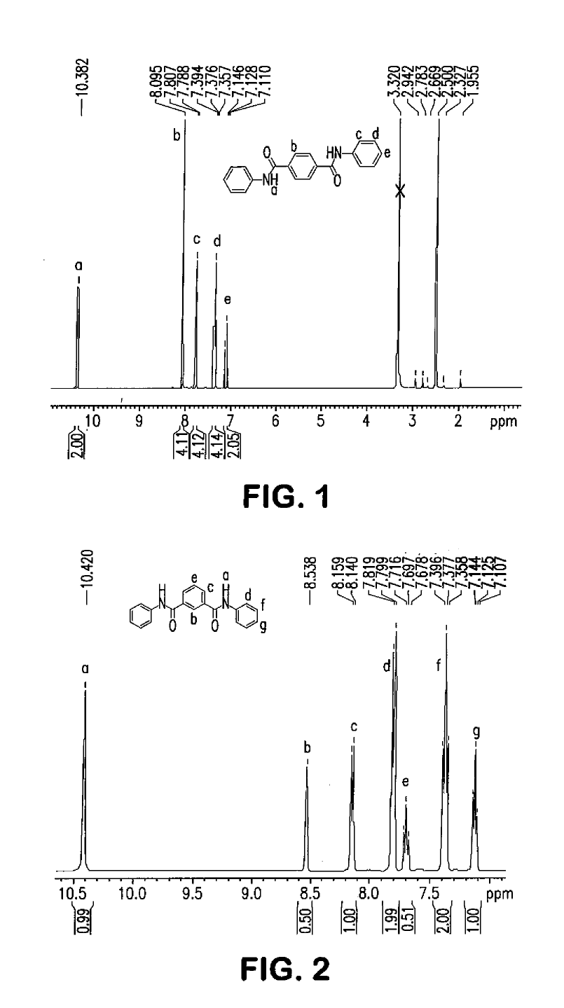

The experimental set up consisted of a 2 L glass beaker equipped with a glass rod stirrer coupled with an overhead mechanical stirrer. Dimethyl acetamide (“DMAc”) (3 L) was added to the beaker and the beaker was immersed in an ice bath to cool the system to 10-15° C. Then aniline (481.6 g) was added to the solvent with constant stirring, the resultant mixture was cooled to 10-15° C. Terephthaloyl chloride (300 g) was added gradually to the cooled stirred mixture such that the temperature of the reaction was maintained below 30° C. The acid chloride was added over a period of one-two hours, after which the mixture was stirred for another three hours at 10-15° C. and then at room temperature overnight. The reaction mixture was milky white (a fine suspension of the product in the solvent) and was vacuum filtered using a filter paper and a Buchner funnel. The crude product was washed with acetone (2 L) and then washed with hot water (2 L). The product was then air dried over night at room temperature and then was dried in a vacuum oven 150° C. for 4-6 hours. The product (464.2 g) was a highly crystalline white solid. The melting point was 346-348° C., as determined by differential scanning calorimetry (“DSC”). The Proton NMR characterization for the compound is shown in FIG. 1.

### Synthesis of N1,N4-Diphenylisoterephthanalide

### Compound B

The synthesis of Compound B from isophthaloyl chloride and aniline was performed according to the following scheme:

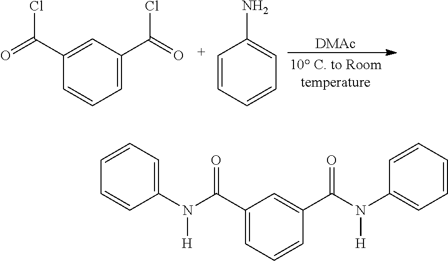

The experimental set up consisted of a 2 L glass beaker equipped with a glass rod stirrer coupled with an overhead mechanical stirrer. DMAc (1.5 L) was added to the beaker and the beaker was immersed in an ice bath to cool the solvent to 10-15° C. Then aniline (561.9 g) was added to the solvent with constant stirring, the resultant mixture was cooled to 10-15° C. Isophthaloyl chloride (350 g dissolved in 200 g of DMAc) was added gradually to the cooled stirred mixture such that the temperature of the reaction was maintained below 30° C. The acid chloride was added over a period of one hour, after which the mixture was stirred for another three hours at 10-15° C. and then at room temperature overnight. The reaction mixture was milky white in appearance. The product was recovered by precipitation by addition of 1.5 L of distilled water and followed by was vacuum filtration using a filter paper and a Buchner funnel. The crude product was then washed with acetone (2 L) and then washed again with hot water (2 L). The product was then air dried over night at room temperature and then was dried in a vacuum oven 150° C. for 4-6 hours. The product (522 g) was a white solid. The melting point was 290° C. as determined by DSC. The Proton NMR characterization for the compound is shown in FIG. 2.

### Synthesis of N1,N4-bis(2,3,4,5,6-pentafluorophenyl)terephthalamide

### Compound C

The synthesis of Compound C from pentafluorophenol and terephthaloyl chloride was performed according to the following scheme:

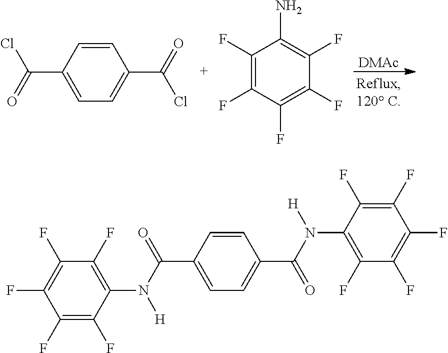

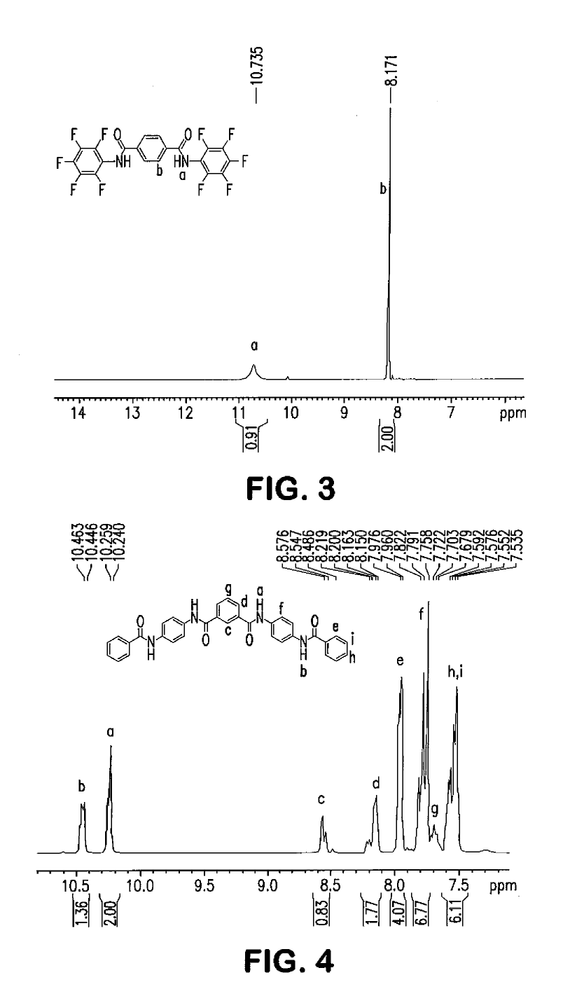

Pentafluoroaniline (10 g) was dissolved in dimethyl acetamide (DMAc) (50 mL) and terephthaloyl chloride (3.7 g) was added in one portion. The reaction mixture was stirred and then refluxed for six (6) hours at 120° C. The reaction mixture was then cooled and 200 mL water was added to the mixture to precipitate the crude product. The product was then filtered and dried. The crude product was then washed with acetone (100 mL) and dried to give a white powder as the final product (6.8 g). The melting point by DSC was 331.6° C. The Proton NMR characterization for the compound is shown in FIG. 3.

### Synthesis of N4-phenyl-N1-[4-[[4-(phenylcarbamoyl)benzoyl]amino]phenyl]terephthalamide

### Compound E

The synthesis of Compound E from 4-amino benzanilide and terephthaloyl chloride, can be performed according to the following scheme:

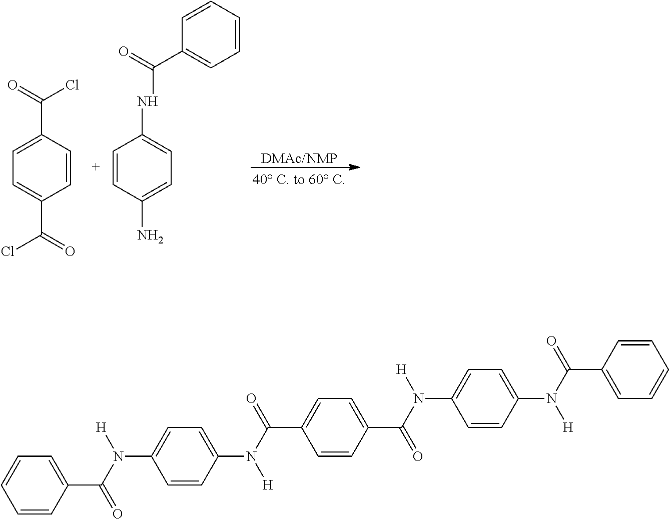

The experimental setup consisted of a 1 L glass beaker equipped with a glass rod stirrer coupled with an overhead mechanical stirrer. 4-aminobenzanilide (20.9 g) was dissolved in warm DMAc (250 mL) (alternatively N-methylpyrrolidone can also be used). Terephthaloyl chloride (10 g) was added to the stirred solution of the diamine maintained at 40-50° C., upon the addition of the acid chloride the reaction temperature increased from 50° C. to 80° C. After the addition of the acid chloride was completed, the reaction mixture was warmed to 70-80° C. and maintained at that temperature for about three hours and allowed to rest overnight at room temperature. The product was then isolated by the addition of water (500 mL) followed by vacuum filtration followed by washing with hot water (1 L). The product was then dried in a vacuum oven at 150° C. for about 6-8 hours, to give a pale yellow colored solid (yield ca. 90%). The melting point by DSC was 462° C.

### Synthesis of N1,N3-bis(4-benzamidophenyl)benzene-1,3-dicarboxamide

### Compound F2

The synthesis of Compound F2 from 1,4-phenylene diamine, terephthaloyl chloride, and benzoyl chloride was performed according to the following scheme:

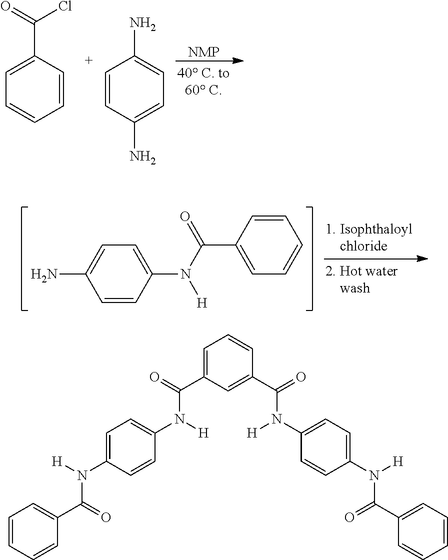

The experimental setup consisted of a 500 mL glass beaker equipped with a magnetic stirrer. 1,4 phenylene diamine (20 g) was dissolved in warm NMP (200 mL) at 40° C. Benzoyl chloride (26.51 g) was added drop wise to a stirred solution of the diamine over a period of 30 minutes. After the addition of the benzoyl chloride was completed, the reaction mixture was warmed to 70-80° C. and then allowed to cool to 50° C. After cooling to the desired temperature, isophthaloyl chloride (18.39 g) was added in small portions such that the temperature of the reaction mixture did not increase above 70° C. The mixture was then stirred for additional one (1) hour at 70° C., and was allowed to rest overnight at room temperature. The product was recovered by addition of water (200 mL) to the reaction mixture, followed by filtration and washing with hot water (500 mL). The product was then dried in a vacuum oven at 150° C. for about 6-8 hours to give a pale yellow colored solid (51 g). The melting point by DSC was 329° C. The Proton NMR characterization for the compound is shown in FIG. 4.

### Synthesis of N1,N3-bis(3-benzamidophenyl)benzene-1,3-dicarboxamide

### Compound G2

The synthesis of Compound G2 from 1,3-phenylene diamine, isophthaloyl chloride, and benzoyl chloride was performed according to the following scheme:

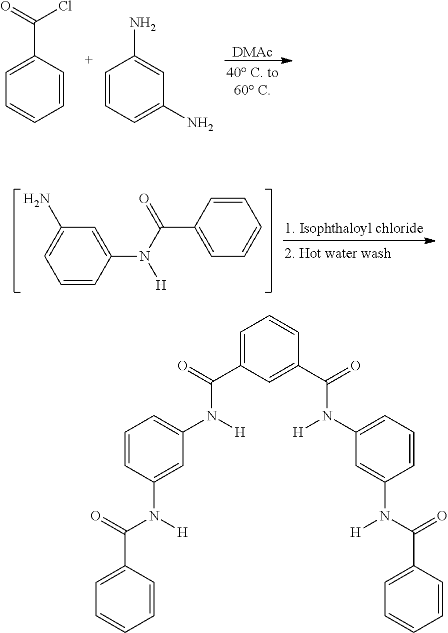

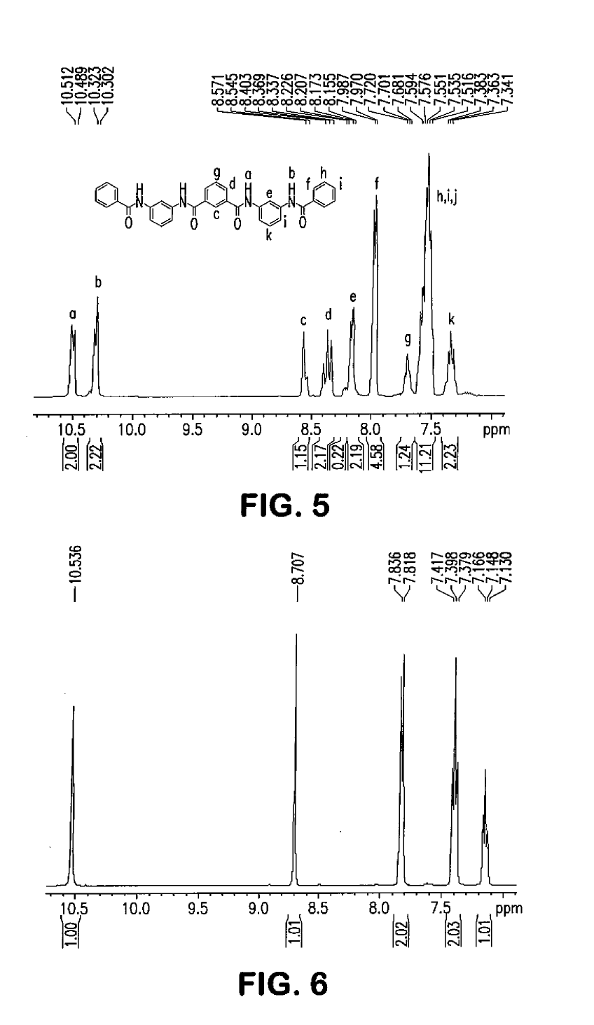

The experimental setup consisted of a 500 mL glass beaker equipped with a magnetic stirrer. 1,3 phenylene diamine (20 g) was dissolved in warm DMAc (200 mL) at 40° C. Benzoyl chloride (26.51 g) was added drop wise to a stirred solution of the diamine over a period of 30 minutes. After the addition of the benzoyl chloride was completed, the reaction mixture was warmed to 70-80° C. and allowed to cool to 50° C. After cooling to the desired temperature, isophthaloyl chloride (18.39 g) was added in small portions such that the temperature of the reaction mixture did not increase above 70° C. The mixture was then stirred for additional one hour at 70° C., and was allowed to rest overnight at room temperature. The product was recovered by addition of water (200 mL) to the reaction mixture, followed by filtration and washing with hot water (500 mL). The product was then dried in a vacuum oven at 150° C. for about 6-8 hours to give a pale yellow colored solid (yield ca. 90%). The Proton NMR characterization for the compound is shown in FIG. 5.

### Synthesis of N1,N3,N5-triphenylbenzene-1,3,5-tricarboxamide

### Compound J

Compound J was synthesized from trimesoyl chloride and aniline according to the following scheme:

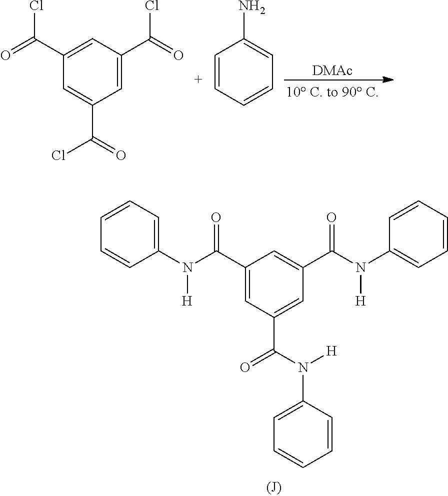

The experimental set up consisted of a 2 L glass beaker equipped with a glass rod stirrer coupled with an overhead mechanical stirrer. Trimesoyl chloride (200 g) was dissolved in dimethyl acetamide (“DMAc”) (1 L) and cooled by an ice bath to 10-20° C. Aniline (421 g) was added drop wise to a stirred solution of the acid chloride over a period of 1.5 to 2 hours. After the addition of the amine was completed, the reaction mixture was stirred additionally for 45 minutes, after which the temperature was increased to 90° C. for about 1 hour. The mixture was allowed to rest overnight at room temperature. The product was recovered by precipitation through the addition of 1.5 L of distilled water, which was followed by was vacuum filtration using a filter paper and a Buchner funnel. The crude product was washed with acetone (2 L) and then washed again with hot water (2 L). The product was then air dried over night at room temperature and then was dried in a vacuum oven 150° C. for 4 to 6 hours. The product (250 g) was a white solid, and had a melting point of 319.6° C., as determined by differential scanning calorimetry (“DSC”). The Proton NMR characterization for the compound is also shown in FIG. 6.

### Synthesis of 1,3-Benzenedicarboxamide, N1,N3-dicyclohexyl

### Compound M1

The synthesis of Compound M1 from isophthaloyl chloride and cyclohexyl amine can be performed according to the following scheme:

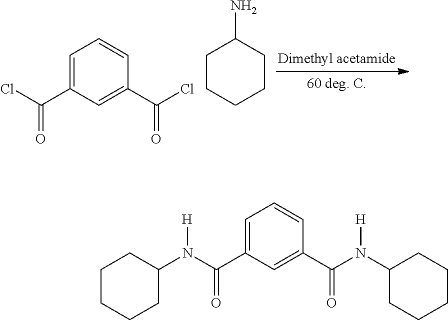

The experimental set up consisted of a 1 L glass beaker equipped with a glass rod stirrer coupled with an overhead mechanical stirrer. Cyclohexyl amine (306 g) was mixed in dimethyl acetamide (1 L) (alternatively N-methylpyrrolidone can also be used) and triethyl amine (250 g) at room temperature. Next isopthaloyl chloride (250 g) was slowly added over a period of 1.5 to 2 hours, to the amine solution with constant stirring. The rate of addition of the acid chloride was maintained such that the reaction temperature was maintained less than 60° C. After complete addition of the benzoyl chloride, the reaction mixture was gradually warmed to 85-90° C. and then allowed to cool to around 45-50° C. The mixture was allowed to rest overnight (for at least 3 hours) at room temperature. The product was recovered by precipitation through the addition of 1.5 L of distilled water, which was followed by was vacuum filtration using a filter paper and a Buchner funnel. The crude product was then washed with acetone (250 mL) and washed again with hot water (500 mL). The product (yield: ca. 90%) was then air dried over night at room temperature and then was dried in a vacuum oven 150° C. for 4 to 6 hours. The product was a white solid. The Proton NMR characterization was as follows: ¹H NMR (400 MHz d₆-DMSO): 8.3 (s, 2H, CONH), 8.22 (s, 1H, Ar), 7.9 (d, 2H, Ar), 7.5 (s, 1H, Ar), 3.7 (broad s, 2H, cyclohexyl), 1.95-1.74 broad s, 4H, cyclohexyl) and 1.34-1.14 (m, 6H, cyclohexyl).

### Example 1

A 2-liter flask was charged with 4-hydroxybenzoic acid (554.6 g) and 2,6-hydroxynaphthoic acid (279.4 g), and 55 mg of potassium acetate. The flask was equipped with a C-shaped mechanical stirrer, a thermal couple, a gas inlet, and distillation head. The flask was placed under a low nitrogen purge and acetic anhydride (99.7% assay, 572.2 g) was added. The milky-white slurry was agitated at 75 rpm and heated to 140° C. over the course of 95 minutes using a fluidized sand bath. The mixture was then gradually heated to 320° C. steadily over 280 minutes. Reflux was seen once the reaction exceeded 140° C. and the overhead temperature increased to approximately 115° C. as acetic acid byproduct was removed from the system. During heating, the mixture grew yellow and slightly more viscous and the vapor temperature gradually dropped to 97° C. Once the mixture had reached 320° C., the nitrogen flow was stopped and the flask was evacuated below 20 psi and the agitation slowed to 30 rpm over the course of 45 minutes. As the time under vacuum progressed, the mixture grew viscous. After 100 minutes, the final viscosity target was reached as gauged by the strain on the agitator motor (torque value of 35 in/oz).

The vacuum was broken and 30 g of Compound A (N1,N4-diphenylterephthalamide), synthesized as described above, was added. The mixture was stirred at 320° C. Compound A appeared to lower the viscosity of the polymer as judged by the increased mobility of the melt, the torque reading being around 18 in/oz. The flask was cooled and then opened to remove the polymer as a solid, dense yellow-brown plug.

### Comparative Example 1

An aromatic polyester was formed as described in Example 1, except that Compound A was not added. It was observed that the agitator torque was higher than that of Example 1 the torque reading being around 54 in/oz. The flask was cooled and then opened to remove the polymer as a solid, dense yellow-brown plug.

### Example 2

A 2-liter flask was charged with 4-hydroxybenzoic acid (579.3 g) and 2,6-hydroxynaphthoic acid (63 g), 4,4′-biphenol (139.7 g), 4-hydroxyacetanilide (50.6), and 44 mg of potassium acetate. The flask was equipped with a C-shaped mechanical stirrer, a thermal couple, a gas inlet, and distillation head. The flask was placed under a low nitrogen purge and acetic anhydride (99.7% assay, 672.0 g) was added. The milky-white slurry was agitated at 75 rpm and heated to 133° C. over the course of 95 minutes using a fluidized sand bath. The mixture was then gradually heated to 350° C. steadily over 310 minutes. Reflux was seen once the reaction exceeded 140° C. and the overhead temperature increased to approximately 115° C. as acetic acid byproduct was removed from the system. During heating, the mixture grew yellow and slightly more viscous and the vapor temperature gradually dropped to 97° C. Once the mixture had reached 350° C., the nitrogen flow was stopped and the flask was evacuated below 20 psi and the agitation slowed to 30 rpm over the course of 45 minutes. As the time under vacuum progressed, the mixture grew viscous. After 100 minutes, the final viscosity target was reached as gauged by the strain on the agitator motor (torque value of 20 in/oz).

The vacuum was broken and 30 g of Compound A was added in one single portion, and the mixture was stirred at 350° C. for 30 minutes. No torque was observed. The reactor was cooled to 335° C. over a period of 60 minutes to determine if lowering the temperature could result in a torque reading. However, even at this temperature, no torque was recorded. After stirring the reaction mixture at atmospheric pressure for almost 2 hours with no torque observed, the reaction was stopped by cooling the flask to room temperature followed by the recovery of the polymer as a solid brown plug.

### Comparative Example 2

An aromatic polyester was formed as described in Example 2, except that Compound A was not added. Also, the reaction mixture was gradually heated to 350° C. over 290 minutes rather than 310 minutes. Contrary to Example 2, an agitator torque was observed within 15 minutes of reducing the reactor temperature and the final torque was 30 in/oz.

The samples of the aforementioned examples were then tested for thermal properties. The results are set forth below.

| Comp. | Comp. Ex. 1 | Example 1 | Comp. Ex. 2 | Ex. 2 |
|---|---|---|---|---|
| Oligomer | — | A | — | A |
| Melt Viscosity | 83.8 | 42.3 | 71.2 | 2.1 |
| (1000 s⁻¹) (Pa-s) | | | | |
| Melt Viscosity | 138.5 | 67.2 | 110.7 | 2.7 |
| (400 s⁻¹) (Pa-s) | | | | |
| Intrinsic Visc. (dL/g) | 9.3 | 7.9 | 8.1 | 3.9 |
| Tm (° C.) | 295.5 | 283.1 | 343.59 | 329.92 |
| Tc (° C.) | 227.99 | 231.04 | 290.97 | 277.95 |

### Example 3

A first sample (Sample 1) was formed. A 2 L flask was charged with 4-hydroxybenzoic acid (415.7 g), 2,6-hydroxynaphthoic acid (32 g), terephthalic acid (151.2 g), 4,4′-biphenol (122.9 g), acetominophen (37.8 g), and 50 mg of potassium acetate. The flask was equipped with C-shaped stirrer, a thermal couple, a gas inlet, and distillation head. The flask was placed under a low nitrogen purge and acetic anhydride (99.7% assay, 497.6 g) was added. The milky-white slurry was agitated at 75 rpm and heated to 140° C. over the course of 95 minutes using a fluidized sand bath. After this time, the mixture was then gradually heated to 360° C. steadily over 300 minutes. Reflux was seen once the reaction exceeded 140° C. and the overhead temperature increased to approximately 115° C. as acetic acid byproduct was removed from the system. During the heating, the mixture grew yellow and slightly more viscous and the vapor temperature gradually dropped to 90° C. Once the mixture had reached 360° C., the nitrogen flow was stopped. The flask was evacuated below 20 psi and the agitation slowed to 30 rpm over the course of 45 minutes. As the time under vacuum progressed, the mixture grew viscous. After 72 minutes, the final viscosity target was reached as gauged by the strain on the agitator motor (torque value of 30 units). The reaction was then stopped by releasing the vacuum and stopping the heat flow to the reactor. The flask was cooled and then polymer was recovered as a solid, dense yellow-brown plug. Sample for analytical testing was obtained by mechanical size reduction.

A second sample (Sample 2) was formed as described for Sample 1, except that 19.65 grams of Compound D was also introduced into the reactor. It was observed that there were fewer residues in the distillate as compared to Sample 1. The reaction was stopped after 72 minutes—no torque was observed on the agitator motor.

A third sample (Sample 3) was formed as described for Sample 1, except that 19.76 grams of Compound J was also introduced into the reactor. It was observed that there were fewer residues in the distillate as compared to Sample 1. The reaction was stopped after 72 minutes—no torque was observed on the agitator motor.

The thermal properties of the melt polymerized prepolymers of Samples 1-3 were tested as described above. The results are set forth below in the following table.

| | | | | | MV at | MV at |
|---|---|---|---|---|---|---|
| | | Tm | | | 1000 s⁻¹ | 400 s⁻¹ |
| Sample | Additive | (° C.) | Tc (° C.) | IV (dL/g) | (Pa * s) | (Pa * s) |
| 1 | — | 361.6 | 301.8 | 8.4 | 75.7 | 118.2 |
| 2 | D | 350.6 | 299.3 | 5.3 | 46.8 | 70.7 |
| 3 | J | 322.4 | 275.1 | 3.8 | 27.7 | 43.6 |

### Example 4

A 300-liter Hastalloy C reactor was charged with 4-hydroxybenzoic acid (65.9 lbs.), 6-hydroxy-2-naphthoic acid (7.2 lbs.), terephthalic acid (2.8 lbs.), 4,4′-biphenol (18.8 lbs.), 4-hydroxyacetanilide (5.8 lbs.), N,N-diphenyl terepthalamide (Compound A) (2.8 lbs.), and 3.4 g of potassium acetate.

The reactor was equipped with a paddle-shaped mechanical stirrer, a thermocouple, a gas inlet, and distillation head. Under a slow nitrogen purge acetic anhydride (99.7% assay, 76.1 lbs.) was added. The milky-white slurry was agitated at 120 rpm and heated to 190° C. over the course of 130 minutes. During this time approximately 42 pounds of acetic acid was distilled from the reactor. The mixture was then transferred to a 190 liter stainless steel polymerization reactor and heated at 1° C./min. to 245° C. At this point a steady reflux of byproduct acetic acid was established which reduced the heating rate to ˜0.5° C./min. When the reaction mixture reached 305° C. reflux was turned off and the batch was allowed to heat at a rate of about 1° C./min. During heating, the mixture grew yellow and slightly more viscous and the vapor temperature gradually dropped below 100° C. as distillation of byproduct acetic acid came to an end. Heating continued until the batch reached the target temperature of 350° C. The nitrogen purge was stopped and a vacuum applied to slowly reduce the pressure to less than 5 mm over a 45 minute period. As the time under vacuum progressed the last traces of acetic acid were removed and the batch became more viscous. After 30 minutes under full vacuum (less than 5 mm) nitrogen was admitted to the system and the molten polymer was extruded from the reactor at 3 PSIG pressure through a 3-hole die plate. The polymer strands were cooled and solidified by running through a water bath and then chopped into pellets.

The polymer had a melting temperature (Tₘ) of 325.6° C. and a melt viscosity of 5.0 Pa-s at a shear rate of 1000 sec⁻¹ as measured by capillary rheology at a temperature of 350° C.

These and other modifications and variations of the present invention may be practiced by those of ordinary skill in the art, without departing from the spirit and scope of the present invention. In addition, it should be understood that aspects of the various embodiments may be interchanged both in whole and in part. Furthermore, those of ordinary skill in the art will appreciate that the foregoing description is by way of example only, and is not intended to limit the invention so further described in such appended claims.

What is claimed is:

1. A method for forming a liquid crystalline polymer, the method comprising:
supplying two or more monomers to a reactor vessel to form a reaction mixture, wherein the monomers are precursors for the liquid crystalline polymer; heating the reaction mixture to initiate a melt polycondensation reaction;
agitating the heated reaction mixture; and
introducing an aromatic amide oligomer into the reactor vessel during agitation of the reaction mixture, wherein the oligomer has a molecular weight of about 3,000 grams per mole or less and contains from 1 to 15 amide functional groups per molecule.

2. The method of claim 1, wherein the liquid crystalline polymer is wholly aromatic.

3. The method of claim 1, wherein the precursor monomers are selected from the group consisting of aromatic or aliphatic hydroxycarboxylic acids, aromatic or aliphatic dicarboxylic acids, aromatic or aliphatic dials, aromatic or aliphatic amines, aromatic or aliphatic diamines, and combinations thereof.

4. The method of claim 3, wherein the reaction mixture comprises two or more aromatic hydroxycarboxylic acids.

5. The method of claim 3, wherein the reaction mixture comprises an aromatic hydroxycarboxylic acid, aromatic amine, and aromatic dicarboxylic acid.

6. The method of claim 1, wherein at least one of the monomers is acetylated before being supplied to the reactor vessel.

7. The method of claim 1, wherein the reaction mixture is heated to a temperature within a range of from about 210° C. to about 400° C. to initiate the melt polycondensation reaction.

8. The method of claim 1, further comprising supplying an acetylating agent to the reactor vessel so that the reaction mixture comprises the acetylating agent and the monomers.

9. The method of claim 8, wherein the acetylating agent is acetic anhydride.

10. The method of claim 8, wherein the reaction mixture is heated to a first temperature to acetylate one or more of the monomers and subsequently to a second temperature to initiate the melt polycondensation reaction.

11. The method of claim 10, wherein the first temperature is within a range of from about 90° C. to about 150° C. and the second temperature is within a range of from about 210° C. to about 400° C.

12. The method of claim 1, wherein agitation of the reaction mixture is performed by rotation of an agitator.

13. The method of claim 12, wherein the rotating agitator has a torque that is not substantially increased after application of the aromatic amide oligomer.

14. The method of claim 1, further comprising applying a suctional pressure to the reactor vessel.

15. The method of claim 14, wherein the oligomer is introduced into the reactor vessel after application of the suctional pressure.

16. The method of claim 1, wherein the aromatic amide oligomer is employed in an amount of from about 0.1 to about 5 parts by weight relative to 100 parts by weight of the reaction mixture.

17. The method of claim 1, wherein the aromatic amide oligomer has a molecular weight of from about 100 to about 1,200 grams per mole.

18. The method of claim 1, wherein the oligomer has from 2 to 8 amide bonds per molecule.

19. The method of claim 1, wherein the oligomer has the following general formula (I): 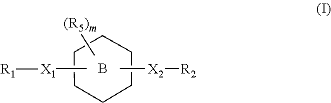
wherein,
ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;
R₅ is halo, haloalkyl, alkyl, alkenyl, aryl, heteroaryl, cycloalkyl, or heterocyclyl;
m is from 0 to 4;
X₁ and X₂ are independently C(O)HN or NHC(O); and
R₁ and R₂ are independently selected from aryl, heteroaryl, cycloalkyl, and heterocyclyl.

20. The method of claim 19, wherein ring B is phenyl.

21. The method of claim 19, wherein ring B is naphthyl.

22. The method of claim 1, wherein the oligomer is selected from the group consisting of the following compounds:

| Structure | Name |
|---|---|
| 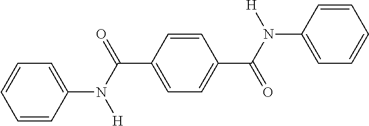 [SMILES: O=C(Nc1ccccc1)c1ccc(C(=O)Nc2ccccc2)cc1] | N1,N4-diphenylterephthalamide |
| 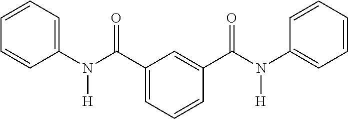 [SMILES: O=C(Nc1ccccc1)c1cccc(C(=O)Nc2ccccc2)c1] | N1,N4-diphenylisoterephthalamide |
| 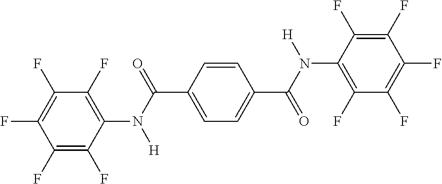 [SMILES: O=C(Nc1c(F)c(F)c(F)c(F)c1F)c1ccc(C(=O)Nc2c(F)c(F)c(F)c(F)c2F)cc1] | N1,N4-bis(2,3,4,5,6- pentafluorophenyl)terephthalamide |
| 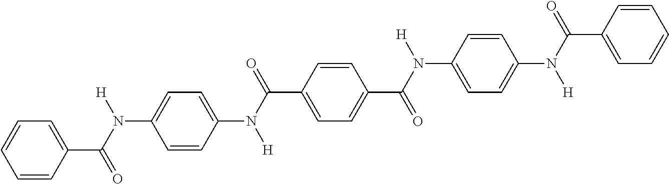 [SMILES: O=C(Nc1ccc(NC(=O)c2ccc(C(=O)Nc3ccc(NC(=O)c4ccccc4)cc3)cc2)cc1)c1ccccc1] | N1,N4-bis(4- benzamidophenyl)terephthalamide |
| 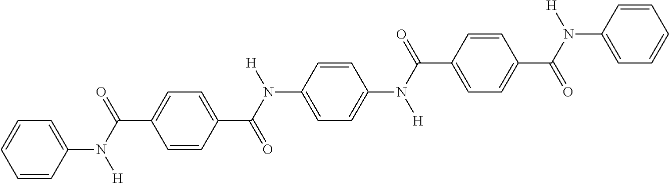 [SMILES: O=C(Nc1ccccc1)c1ccc(C(=O)Nc2ccc(NC(=O)c3ccc(C(=O)Nc4ccccc4)cc3)cc2)cc1] | N4-phenyl-N1-[4-[[4- (phenylcarbamoyl)benzoyl]amino] phenyl]terephthalamide |
| 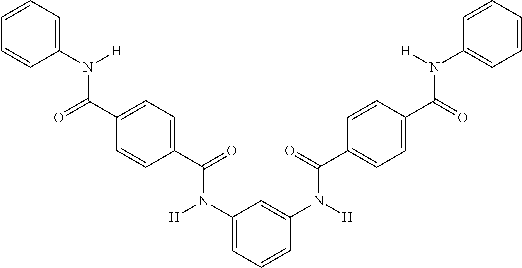 [SMILES: O=C(Nc1ccccc1)c1ccc(C(=O)Nc2cccc(NC(=O)c3ccc(C(=O)Nc4ccccc4)cc3)c2)cc1] | N4-phenyl-N1-[3-[[4- (phenylcarbamoyl)benzoyl]amino] phenyl]terephthalamide |
| 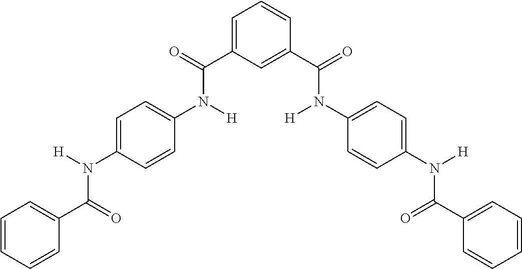 [SMILES: O=C(Nc1ccc(NC(=O)c2cccc(C(=O)Nc3ccc(NC(=O)c4ccccc4)cc3)c2)cc1)c1ccccc1] | N1,N3-bis(4- benzamidophenyl)benzene-1,3- dicarboxamide |
| 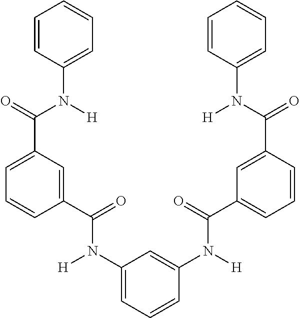 [SMILES: O=C(Nc1ccccc1)c1cccc(C(=O)Nc2cccc(NC(=O)c3cccc(C(=O)Nc4ccccc4)c3)c2)c1] | N3-phenyl-N1-[3-[[3- (phenylcarbamoyl)benzoyl] amino]phenyl]benzene-1,3- dicarboxamide |
| 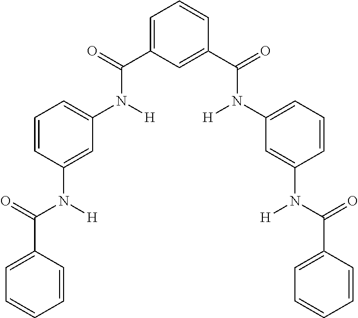 [SMILES: O=C(Nc1cccc(NC(=O)c2cccc(C(=O)Nc3cccc(NC(=O)c4ccccc4)c3)c2)c1)c1ccccc1] | N1,N3-bis(3- benzamidophenyl)benzene-1,3- dicarboxamide |
| 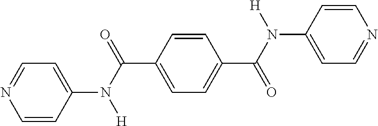 [SMILES: O=C(Nc1ccncc1)c1ccc(C(=O)Nc2ccncc2)cc1] | N1,N4-bis(4- pyridyl)terephthalamide |
| 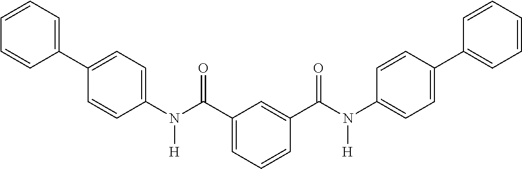 [SMILES: O=C(Nc1ccc(-c2ccccc2)cc1)c1cccc(C(=O)Nc2ccc(-c3ccccc3)cc2)c1] | N1,N3-bis(4- phenylphenyl)benzene-1,3- dicarboxamide |
| 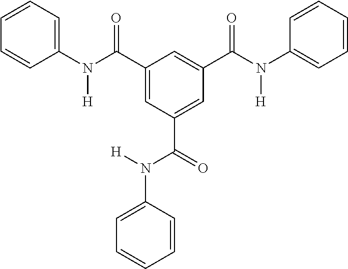 [SMILES: O=C(Nc1ccccc1)c1cc(C(=O)Nc2ccccc2)cc(C(=O)Nc2ccccc2)c1] | N1,N3,N5-triphenylbenzene-1,3,5- tricarboxamide |
| 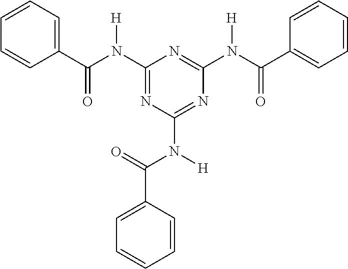 [SMILES: O=C(Nc1nc(NC(=O)c2ccccc2)nc(NC(=O)c2ccccc2)n1)c1ccccc1] | N-(4,6-dibenzamido-1,3,5-triazin- 2-yl)benzamide |
| 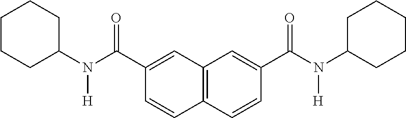 [SMILES: O=C(NC1CCCCC1)c1ccc2ccc(C(=O)NC3CCCCC3)cc2c1] | N2,N7-dicyclohexylnaphthalene- 2,7-dicarboxamide |
| 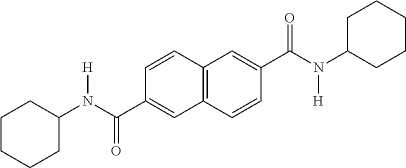 [SMILES: O=C(NC1CCCCC1)c1ccc2cc(C(=O)NC3CCCCC3)ccc2c1] | N2,N6-dicyclohexylnaphthalene- 2,6-dicarboxamide |
| 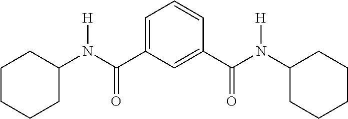 [SMILES: O=C(NC1CCCCC1)c1cccc(C(=O)NC2CCCCC2)c1] | 1,3-Benzenedicarboxamide, N1,N3-dicyclohexyl- |
| 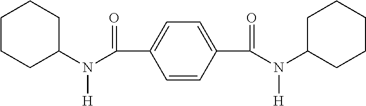 [SMILES: O=C(NC1CCCCC1)c1ccc(C(=O)NC2CCCCC2)cc1] | 1,4-Benzenedicarboxamide, N1,N3-dicyclohexyl- |

23. The method of claim 1, wherein the oligomer is N1,N4-diphenylterephthalamide, 1,3-benzenedicarboxamide, N1,N3-dicyclohexyl, or 1,4-benzenedicarboxamide, N1,N3-dicyclohexyl.

24. A method for forming a liquid crystalline polymer, the method comprising:
supplying two or more monomers and an acetylating agent to a reactor vessel to form a reaction mixture, wherein the monomers are precursors for the liquid crystalline polymer;
heating the reaction mixture to a first temperature to acetylate the monomers and to a second temperature to initiate a melt polycondensation reaction;
agitating the heated reaction mixture; and
introducing an aromatic amide oligomer into the reactor vessel during agitation of the reaction mixture, wherein the oligomer has a molecular weight of about 3,000 grams per mole or less and contains from 1 to 15 amide functional groups per molecule.

25. The method of claim 24, wherein the liquid crystalline polymer is wholly aromatic.

26. The method of claim 24, wherein the aromatic amide oligomer is employed in an amount of from about 0.1 to about 5 parts by weight relative to 100 parts by weight of the reaction mixture.

27. The method of claim 24, wherein the aromatic amide oligomer has the following general formula (I): 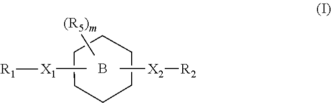
wherein,
ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;
R₅ is halo, haloalkyl, alkyl, alkenyl, aryl, heteroaryl, cycloalkyl, or heterocyclyl;
m is from 0 to 4;
X₁ and X₂ are independently C(O)HN or NHC(O); and
R₁ and R₂ are independently selected from aryl, heteroaryl, cycloalkyl, and heterocyclyl.
